(19) United States
(12) Patent Application Publication
(10) Pub. No.: US 2024/0215549 A1
(43) Pub. Date: Jul. 4, 2024

(54) A SYSTEM AND METHOD FOR LIGHT TREATMENT OF POLLINATING INSECTS

(71) Applicant: Beefutures Holding AS, Oslo Oslo (NO)

(72) Inventor: Christophe BROD, Oslo (NO)

(21) Appl. No.: 17/782,590

(22) PCT Filed: Dec. 4, 2020
(86) PCT No.: PCT/NO2020/050306

§ 371 Date: Nov. 8, 2022

(30) Foreign Application Priority Data
Dec. 6, 2019 (NO) 20191451

(51) Int. Cl. A01K 47/06

(52) U.S. Cl. CPC A01K 47/06

(57) ABSTRACT

A system and method for light treatment of pollinating insects comprising: a hive structure comprising at least one hive compartment box comprising multiple frames spaced apart inside the at least one hive compartment box and an entrance chamber positioned bellow the at least one hive compartment box, wherein the entrance chamber is in contact with the at least one hive compartment box, and comprises an entrance for pollinating insects to enter and exit the hive structure, and: a light therapy device.

### FIELD OF THE INVENTION

The present invention relates to system and method for light treatment of pollinating insects. More specifically it relates to a hive structure comprising a light therapy device.

### BACKGROUND OF THE INVENTION

The number of bees in the world is dropping dramatically each year and estimates show that up to a third of Europe's bee population and a fourth of Europe's bumble bee population are endangered. Given that bees pollinate around one-third of food crops and 90 percent of wild plants, the consequences of this ecological disaster are alarming for biodiversity, the food chain and, not least, our ability to feed ourselves. The bee's pollination contributes to up to 30% of the world's fruit and vegetable production and animal feed for grazing animals. A reduction in bee population is thus a sharp reduction in food production.

The cause for this is likely linked to an un-unprecedented sum of challenges. While some of the threats are individually fatal for bees, it is surely the cocktail of multiple stressing and pressing factors which is causing their dramatic downfall, among them is the colony collapse disorder (CCD).

The CCD occurs when a majority of worker bees in a colony simply disappear—due, scientists believe, to the use of a new class of pesticides, neonicotinoids. Neonicotinoids are a class of neuro-active insecticides chemically similar to nicotine. They are active substances used in plant protection products to control harmful insects, which means they are insecticides. Among other things, neonicotinoids increase bees' susceptibility to the deadly varroa mite, their number one killer.

Studies have shown that a combination of neonicotinoids exposure, pollution, lack of food, decrease of biodiversity and biological variation in farmed areas, climate change and the increase of hostile enemies such as the parasitic mite Varroa destructor and the Asian giant hornet Vespa mandarinia are all contributing to the bees decline in population.

Recent founds show that when bees cat a low sugar diet, which is typically the case in winter or in intensive low biodiversity agriculture areas, the bees are 50 percent more likely to die as a result of neonicotinoid exposure. And it is this cocktail of hostile environments that seems to cause the bees to become weaker from neonicotinoids together with an energy poor diet, causing them to not have the necessary energy to travel the necessary distances to gather food, loosing even more energy and finally being killed in large numbers by enemies or dying from exhaustion.

The research article “Improving Mitochondrial Function Protects Bumblebees from Neonicotinoid Pesticides” by Powner et al. published in 2016 has shown that exposing bumblebees (Bombus terrestris audax) with near infrared light with a wavelength of 670 nm may increase their mitochondrial production of adenosine triphosphate (ATP). Corrected ATP levels in individuals exposed to insecticides such as neonicotinoids showed significant improvements in mobility allowing them to feed. The article teaches that deep red-light exposure improves mitochondrial function, reverses the sensory and motor deficits induced by neonicotinoid. The test was carried out by placing the bees in a transparent plastic container and exposing the bumblebees to light. The article estimates that the true impact of this deep red light is likely much greater than revealed in the ATP and Metabolic functions tests.

The drawbacks of the known methods that it is impossible to treat or heal bees in the wild and the optimum exposure required in a hive is not known, which could result in causing harm and more damaged to a population if wrongly executed (measured and documented by the applicant). It is also believed that the method did not control for, or the test was not aimed at, all the benefits of light exposure.

These benefits are increased mobility, improved immunity, reduced oxidation at cellular level, improved retinal function and memory of the bees, and improved respiration as well as a result of mitochondrial function improvement. Test carried out has also demonstrated increased metabolic metrics improvement for bee colonies exposed to other stress factors such as Asian Hornet. Varroa mite and dearth period.

The patent application WO 2018/165051 A1 teaches a translucent hive for treating honey bee colonies against destructive insect such as Varroa. The translucent hive has at least one outer wall transparent to light from the outside. In another embodiment disclosed in WO 2018/165051 A1 an illuminator board 1900 is placed under a translucent wall in the bottom of the hive. The teachings of WO 2018/165051 A1 has the drawbacks of hindering the natural flow of bees as the bottom board stop bees from entering and exiting the compartment from the bottom. Further drawback of the known prior art is the poor illumination of the bees and the lack of control of over or under exposure. The document CN 1105221635 A teaches a beehive for observing physiological activities of bees inside a hive, where light slots 1-1-1 in the top cover covers provides light exposure from the outside to the inside to provide light for an arrangement of cameras inside the hive. CN 1105221635 A merely discloses a way to provide working light for cameras.

The light therapy exposure, light coverage and the wavelength configuration are critical to ensure maximum biological response.

It is an aim of the present invention to treat pollinating insects in the wild and further increase energy levels due to lack of food, old age and other diseases together with improved metabolism and motivation and energy to fight parasites and predators. It is further an aim of the present invention to correctly expose pollinating insects ensure maximum biological response and avoid damaging by incorrect treatment. Timing of the exposure is also critical and season depending, the solution ensures optimal biological response by adapting exposure time and duration depending on the time of the year and the bee colony activity level.

### SUMMARY OF THE INVENTION

The invention is set forth and characterized in the main claims, while the dependent claims describe other characteristics of the invention.

It is thus provided a system for light treatment of pollinating insects comprising; a hive structure comprising at least one hive compartment box comprising multiple frames spaced apart inside the at least one hive compartment box and an entrance chamber positioned bellow the at least one hive compartment box, wherein the entrance chamber is in contact with the at least one hive compartment box, and comprises an entrance for pollinating insects to enter and exit the hive structure, and; a light therapy device.

The light therapy device comprises at least one light unit, wherein the at least one light unit, when turned on, emits light with a predetermined beneficial wavelength, wherein the least one light unit is positioned; inside of the at least one hive compartment box fastened to or in at least one of the side walls of said at least one hive compartment box, wherein the at least one light unit has a vertical extent and is positioned on or in the at least one wall between the position of at least two frames, in a manner illuminating a space created by the void between at least two frames, and/or; inside the entrance chamber, wherein the at least one light unit is positioned on or in at least one wall inside the main entrance chamber. The at least on light unit is fixated in corresponding groove(s) in the wall, wherein the grooves has a depth corresponding to the width of the light unit for the light units to not protrude the walls and into an open space inside the of the at least one hive compartment box or inside the main entrance chamber

In one embodiment the at least one light unit comprises at least one light emitting diode (LED) or multiple light emitting diodes (LEDs) configured in a strip arrangement.

In another embodiment the predetermined beneficial wavelength is preferably between 620-1000 nm, and more preferably between 640-700 nm, and even more preferably between 660-680 nm.

In yet another embodiment, the at least one light unit, positioned inside of the at least one hive compartment box, has a vertical extent of at least half the height of the frames.

In yet another embodiment, the at least one light unit, positioned inside of the at least one hive compartment box, has a vertical extent of less than half the height of the frames.

In yet another embodiment the light unit is positioned on the top half of the wall inside the at least one hive compartment box.

In yet another embodiment the at least one light unit if positioned inside the entrance chamber, has a longitudinal extent corresponding to at least half the width or longer of the wall where the light unit is positioned.

In yet another embodiment the at least one light unit is positioned on or in at least two of the walls in the entrance chamber, wherein the said two walls are opposing each other.

In yet another embodiment the previous claims, comprising at least two light units when positioned inside of the at least one hive compartment box, wherein the at least two light units is positioned on opposing walls, respectively, aligned in the space between at least two frames.

In yet another embodiment previous claims, comprising at least two light units when positioned inside of the at least one hive compartment box, wherein the light units are positioned on or in at least one wall and between one or multiple pair(s) of opposing frames, wherein the distance between the light units corresponds to a distance equal to the distance of the frames

In yet another embodiment the hive structure further comprises a top module positioned on top of the at least one hive compartment box, wherein the top module comprises at least one light unit emitting light with a predetermined beneficial wavelength when turned on, wherein the least one light unit is downward facing and positioned in to the open space crated between two opposing frames in the at least one hive compartment box in a manner emitting light between the frames of the at least one hive compartment box.

In yet another embodiment the system further comprises a control unit for selectable switching the light therapy device on or off

In yet another embodiment the control unit for selectable switching the light therapy device on or off is remotely configurable via a remote control.

In yet another embodiment the control unit is configurable to control parameters for predetermined light intervals, wherein said parameters is at least on of; the light exposure duration, the duration of the off-time, the frequency of the intervals.

In yet another embodiment the at least one light unit is powered by at least one battery and/or at least one external power source and/or at least one power generating device.

In yet another embodiment the pollinating insects are honey bees, bumblebees or osmia bees.

Further aims of the present invention is set forth in another independent claim, wherein it is provided a system for light treatment of pollinating insects comprising a hive structure comprising at least one hive compartment box comprising a pair of parallel opposing shelf like grooves on the inside portion of two opposing wall structures of the at least one hive compartment box, wherein the opposing grooves are adapted to receive multiple frames spaced apart, and a light therapy device. The light therapy device comprises at least one light unit, wherein the at least one light unit, when turned on, emits light with a predetermined beneficial wavelength, wherein the light therapy device is positioned inside the at least one hive compartment box and being releasably attached to the at least one hive compartment box with attachment means.

Further aims of the present invention is set forth in yet another independent claim wherein it is provided a system for light treatment of pollinating insects comprising at least one hive compartment box adapted for receiving multiple frames spaced apart inside, an entrance chamber positioned bellow the at least one hive compartment box, wherein the entrance chamber is in contact with the at least one hive compartment box, and comprises an entrance for pollinating insects to enter and exit the hive structure, and a top module positioned on top of the at least one hive compartment box. The top module is positioned on top of the at least one hive compartment box, wherein the top module comprises a light therapy device wherein the light therapy device is comprising at least one light unit, wherein the at least one light unit, when turned on, emits light with a predetermined beneficial wavelength. The attachment means may comprise a pair of notches, each notch protruding from opposite sides, respectively, of the light therapy device and wherein the opposite protruding notches corresponds to the opposing grooves on the inside of the at least one hive compartment box

It is also provided a method for treatment of pollinating insects inside at least one hive comprising the system according to any one the embodiments, wherein the method comprises the steps of; a) housing pollinating insects inside said hive, and; b) selecting a predetermined interval for turning the at least one light unit of the light therapy device on and off, c) illuminating the pollinating insects for the predetermined time intervals with the at least one light unit.

### BRIEF DESCRIPTION OF THE DRAWINGS

FIG. 1 shows a side view of a hive

FIG. 2 shows a front view of a hive

FIG. 3 shows a front view of a hive and light units

FIG. 4 shows a front view of a hive, frames and light units

FIG. 5 shows a slanted view of a hive without the top cover

FIG. 6 shows a slanted view of a hive without the front portion, and a light unit and groove magnified.

FIG. 7 shows a slanted view of a hive with the front portion removed and tall light units

FIG. 8 shows a slanted view from bellow of a hive with light units in the top module, compartment box and bottom entrance chamber.

FIG. 9 shows a front view of a hive with two compartment boxes stacked on top of each other

FIG. 10 shows a front view of a hive with two compartment boxes stacked on top of each other and light units in the top module, both compartment boxes and the entrances chamber box

FIG. 11 shows a slanted view of a hive with frames.

FIG. 12 shows a slanted view of a hive with frames wherein the frames are transparent to illustrate the placement of the light units together with the frames.

FIG. 13 shows a see-through front view of a hive with the light therapy device in a frame-embodiment.

FIG. 14 shows a see-through side view of a hive with the light therapy device in a frame-embodiment.

FIG. 15 shoes shows a see-through front view of a hive with the light units in the bottom board.

### DETAILED DESCRIPTION OF THE INVENTION

The following description will use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting. It should be understood that the terms pollinating insects or insect pollinators is used for bees, honey bees, bumblebees, osmia bees and other insects cultivated and managed by humans in hives. And the use of either bee or honey bee is for the reader's convenience only and shall not be limiting. A hive is any man-made structure or artificial nest used to cultivated and managed pollinating insects.

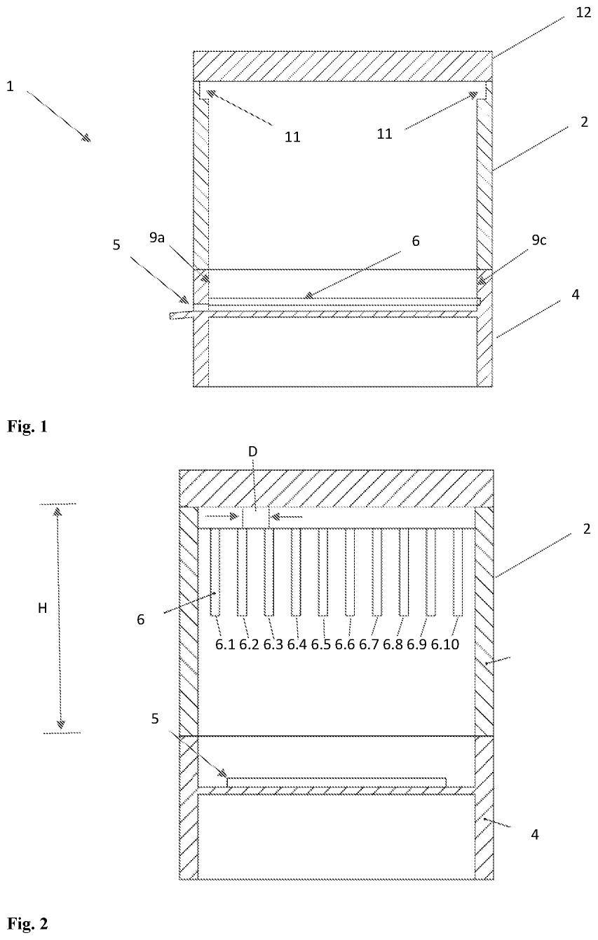

A typical hive, as illustrated in FIG. 1, is typically an artificial nest or structure made to house and keep a colony of pollinating insects such as honey bees, bumblebees, or other insects, for the purpose of producing and harvesting honey, pollinating crops or raise and house bees for other purposes.

Typically, a vertical hive bee hive structure comprises at least one hive compartment box for the queen to lay egg and at least one hive compartment box positioned on top of the first box to store honey. These boxes are sometimes known as brood box and honey super box, respectively. Typical for these hive compartment boxes is that they comprise four upright quadrilateral wall plates in a quadrilateral lay out in a manner forming a four-sided box open in the top and bottom. Inside the box a number of vertical frames are typically hanging or fastened from the top edge portion of two opposing walls. The frames have a height corresponding to, or less than the height of the wall plates, and a width corresponding to less than the internal width of the box.

The frames are used for holding an storing hexagonal prismatic cells made of honeycomb. The bees use the cells to store honey and pollen in the honey super box, and to house the eggs, larvae, and pupae in the brood box.

In a typical hive there may be between 5-12 frames inside the brood or honey super box each, however any number of frames may be used, which would be obvious to a person skilled in the art. Furthermore, multiple hive compartment boxes may be stacked on top of each other, either with a separating part, such as a queen excluder or other functional separator in between the boxes, or in direct contact. In situations where the production and storage of honey is not the objective, or any other reason for a bee keeper to not store honey, a hive can exist with only one hive compartment box. i.e. no honey super box. The size and dimensions of the hive may vary according to the type of hive used. Hives may typically be constructed from wood, closed-cell extruded polystyrene foam (XPS) or other types of suitable materials such as plastic.

There exist a large variety of different hives, wherein there is two main categories; vertical hooves or horizontal hives. The most typical types of hives honey bees are Langstroth hive. Dadant hive. Warré hive, WBC hives, CDB hives. Perone hives. Norwegian standard hive. UK standard hive and German standard hive. In patent EP 3041349 B1 a list of hives and measurements for the hives are listed in Table 1. All of these hives may be used in a system in accordance with the embodiments of the invention defined in the claims.

Hives adapted for osima bees and bumblebees are often of simpler construction than hives adapted for honey bees. Bumblebee hives does not have frames and may comprise of only one hive compartment box and an entrance and exit, and osima bee hives comprises multiple holes or tunnels in an otherwise solid construction. It should be understood that the light therapy device in accordance with the disclosure herein may also be used on hives for bumblebee hives and osima bee hives.

Furthermore, a hive structure may comprise an entrance chamber box positioned on the bottom of the stack. The entrance chamber box may be a bottom board comprising separate entrance chamber positioned bellow the at least one hive compartment box and/or traps and screens for entrance control.

On top of the hive, a cover is used as a roof. Typical covers may be a telescopic cover or a migratory cover that's seals the top hive compartment box from rain, cold or heat.

It should be obvious to a person skilled in the art that any combination of number of boxes, compartments, functional disclosures, types and sizes of hives for pollinating insects and honey bees may be suitable for the present inventions disclosed herein.

### Light Therapy Device

The light therapy device comprises at least one light unit, wherein the at least one light unit may be positions in different compartments or boxes of the hive. The at least one light unit comprises at least one light emitting diode (LED). And in an embodiment of the invention, the light units comprise multiple LEDs configured in a strip arrangement. This strip arrangement of LEDs may be housed in a transparent protective material to protect the LEDs from honey, pollen, wax, comb or bees or be embedded inside groove(s) or longitudinal cut outs in the portions of the hive where they are positioned. In order for the bees not to be obstructed by the light units inside the hive, it is beneficial for the light units not to protrude out in the available space inside the hive. The free, or open, space between frames and between frames, walls and other restricting enclosures, such as roof cover or bottom, serves a crucial function inside the hive. If these spaces become to large or to small, the habituating bees will either close with propolis or build comb in them. By placing the light units inside the material of the hive, the bees will not be obtruded, and the free space will not be affected. For instance the light unit should preferably be positioned inside a hive compartment box in a manner not protruding the wall of the box. The strip of LEDs is positioned inside the vertical groove 8 in the walls.

In an embodiment of the invention one light unit may be positioned in a hive compartment box comprising internal frames, such as a brood box, and one light unit may be positioned in the bottom board part of the hive. In said example, the light therapy device comprises two light units, wherein each light unit may be comprised of several LED strips or several single LEDs.

In another embodiment of the invention the light therapy device may further comprise a light unit positioned in a top module 12, wherein the top module may be any suitable top covering device positioned on top of the hive stack, this includes traditional covers modified with light units or purpose build top modules.

The LEDs are electronically connected via wire. The at least one light unit is powered by a power source. The power source may be an external power source in the form of power mains or the like, one or multiple batteries, renewable power sources such as a solar panel, wind generator or a combination of said sources.

Bees exposed to light at 670 nm has been shown to fully recover their mitochondria functions and ATP production, thus reversing the sensory and motor deficits induced by Neonicotinoid. Studies have also shown recovery of the immune response to bacterial tests. The spectrum of light with a wavelength of between 620-1000 nm has also shown effects of restoring the metabolic function of bees that have been poisoned by pesticides. The lights unit(s) comprised in the system according to the present invention emits light with a predetermined beneficial wavelength, wherein the beneficial wavelength is preferably between 620-1000 nm. However, in situations where it would be beneficial for a human to visually control if the light therapy device was turned on or off, it is necessary to keep the light in the visual human spectrum. The visual light spectrum for humans is considered to be from 380 to 740 nm, thus rendering humans unable to see light above 740 nm. Therefore, the beneficial wavelength in accordance with the intentioned is more preferably between 640-700 nm, and even more preferably between 660-680 nm.

The bees have different levels of activity during a year, and the times for when pesticides are used on a crop is also dependent on the time of the year. Therefore, in an embodiment of the invention, the system further comprises a control unit for selectable switching the light therapy device on or off, to maximize biological response to the light therapy. Crucially, the control unit controls when the light therapy device is turned on or off, and for how long the duration of the on- or of-periods should be, and the number of cycles in a predetermined time the on- or off-periods should last. The control unit may be configurable to control parameters for predetermined light intervals, wherein said parameters is at least on of; the light exposure duration, the duration of the off-time, the frequency of the intervals.

In an embodiment of the invention the control unit for selectable switching the light therapy device on or off is remotely configurable via a remote control. The remote-control system may be comprised of either a wired or wireless transmitting and receiving means.

The light therapy device will, in a embodiment of the invention, emit infrared or close to infrared light with a wavelength of preferably between 620-1000 nm, and more preferably between 640-700 nm, and even more preferably between 660-680 nm. The LED as comprised in the light unit, should preferably be capable of emitting light where at least 68.26% of the light emitted has wavelength of between 660-680 nm or more preferably at least 95.44% of the light emitted has a wavelength of 660-680 nm. Alternatively, the peak wavelength λₚ should be around 670 nm in a spectral power distribution. A spectral power distribution refers to the concentration of wavelength of radiometric or photometric quantity, and in this case, the peak wavelength of a spectral power distribution should be understood as the wavelength with the highest power per unit area per unit wavelength of an illumination.

In an embodiment of the invention the light therapy device is activated and deactivated i.e. the light unit is turned on or off, by the signal from at least one sensor. The effect of this is that the healing and therapeutic effect function is automatically triggered when needed or when external influences renders light treatment most efficient and needed. To achieve this effect, a control unit, adapted to control the power to, and thereby the on/off-functionality of, the light unit, might be triggered by receiving signals or measurements on abnormal bee colony metrics. These abnormal bee colony metrics can be—CO2 values, where for instance high CO2 value relative to colony size could indicate degraded respiration ability of the bees and poorer metabolic rate and declining immunity,—abnormal colony size decline and/or -detection of pesticides.

These signals or metrics that may indicate abnormal bee colony metrics may measurements using at least one sensor. To measure the CO2 value a CO2 sensor and/or oxygen sensor is used. To measure the size of the colony and the rate of change in the colony, a counting device such as a camera counting and registering bees in and out of at least one entrance is use. A weight measuring device might be used, either on its own or as an addition to the camera counting device, used to monitor the weight of the hive or parts of the hive thereof, and thereby the colony, and whereby a sudden or abrupt decrease in weight measured will indicate that bees are leaving the hive in large numbers. Said counting sensors also capable of registering a sudden bee drift. i.e. non-returning bees from foraging, which is a is a clear sign of poisoning. Said bee drift is detected and measured by counting leaving and entering bees with a camera and video-based sensor device coupled, by at least signal transfer means and/or electrical transfer means, to a computer device. Whereby the computer device is running an image reconditioning software capable of detecting and counting bees. Alternatively. or in addition to said visual sensor, an electronic bee counter gate which registers bees in and out through the gate might be used.

The effect of the automatically controlled control of the light therapy device is both to expose the bees to light at optimal times, and to reduce exposer when it might not be beneficial. At times, it might not be optimal to ensure the longevity of old bees by way of the present invention, but rather promote the queen bee to lay eggs. For instance, if a bee colony is not particularly stressed or there is no particular sign of decline, the light therapy device will facilitate to keep old bees alive longer than normal and cause the colony to be too large at a peak point. The queen may regulate the situation by stopping laying eggs or bees themselves might trigger a swarm because of storage and space lack in a crowded hive. In other words, if there is no sign of colony decline it might not be desirable to treat the bees with light as it could trigger abnormal colony evolution and negative side effects. To ensure that the correct timing of light exposure, the light therapy device may comprise a control device which receives input from at least one sensor, as described above.

### DETAILED DESCRIPTION OF THE DRAWINGS

FIG. 1 illustrates a side view typical hive structure 1 with a top module or cover 12, a hive compartment box 2 beneath the top cover 12, wherein the hive compartment box 2 has opposing top shelf like grooves 11 for the placement of vertically hung frames 3. The hive compartment box 2 is located on top of the entrance chamber box 4 comprising the entrance 5 for the bees to enter and exit the hive compartment box 2 via the entrance chamber box 4. The figure shows a light unit 6 in the entrance chamber box 4. The light unit 6 shown has a length, or extent, in the longitudinal plane and runs from the entrance 5, or the wall 9a of the entrance chamber box 4 and to the wall 9c opposite of the entrance 5, running at least the length of the side wall 9b. The side walls 9b. 9d are the two walls perpendicular the wall 9a comprising the entrance 5. Other entrances may be positioned on top or in other locations.

FIG. 2 illustrates a front view of hive 1 in accordance with certain embodiments of the invention wherein multiple light units 6 are positioned in the hive compartment box 2. In the illustrated example ten light units 6.1-6.10 is positioned inside the hive compartment box 2, each positioned a distance apart corresponding to the predetermined distance D between the frames (not shown in this figure), wherein the light units 6 are vertically oriented LED strips, with a vertical height, or extent substantially in the vertical direction, of less than half the height H of the hive compartment box 2. In a non-illustrated example, the hive compartment box 2 comprises light units 6 in pairs, each unit of a par is positioned on opposing walls in a manner illuminating the open space between the pair of opposing light units.

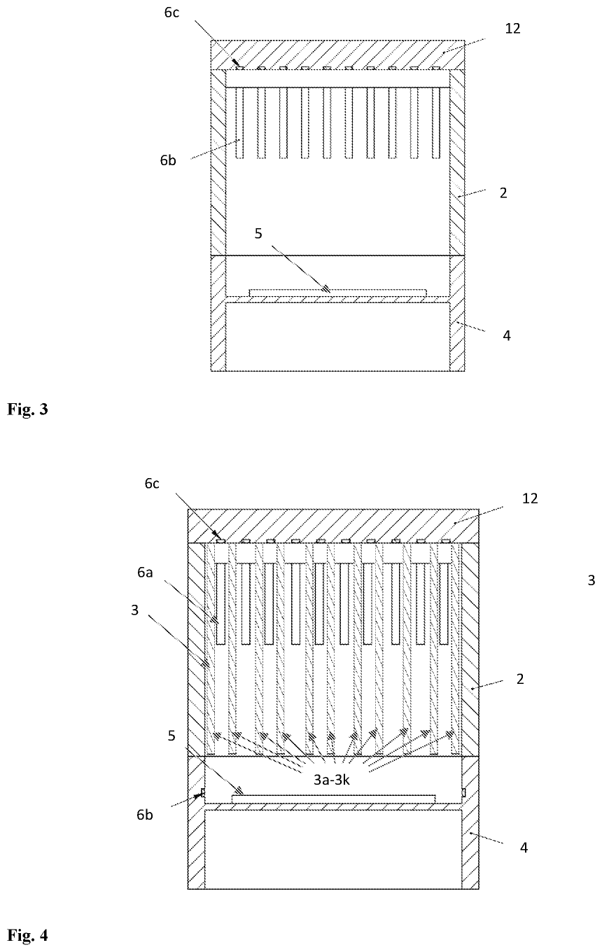

FIG. 3 illustrates a front view an example of the system according to an embodiment of the invention where ten light units 6a are located inside the hive compartment box 2 and ten light units 6c are located in the top module 12. In the illustrated example the light units 6a in the hive compartment box 2 illuminates the spaces created by the void between two and two frames 3 (not shown), when the frames are positioned a predetermined distance apart, from the sides, and the light units 6c in the top module 12 illuminates the spaces created by the void between two and two frames 3, when the frames are positioned a predetermined distance apart, from the top. This illumination from multiples angle ensures coverage of the bees even if one light unit should be obstructed by either a cluster of bees or other elements inside the hive. Furthermore, the different light unit placements 6a. 6b. 6c gives the flexibility of altering the intensity of luminosity by altering the number of light units and from where the units are illuminating. This alternation of the number of light units 6 can either be done by removing or adding an entire light unit or module 2a. 2b, for instance when a time of the year requiring less or more, respectively, treatment intensity, or by switching the different light units on or off, via the control unit. This is beneficial as the intensity of the treatments that is necessary to achieve optimum biological response varies greatly from different times of the day to different times of the year. Optimum biological response should be understood as maximum beneficial effects, as previous described. The frames have a height corresponding to or less than the height H of the wall plates, and a width corresponding to less than the internal width of the box. The frames 3 typically has notches 14 on the top on either side corresponding to the grooves for receiving said frame notches 14.

FIG. 4 illustrates an example where two light units 6b are located inside the entrance chamber box and ten light units 6a are located inside the hive compartment box 2 and ten light units 6c are located in the top module 12. The number of light units inside the hive compartment box 2 and in the top module 12 is in most cases governed by the number of frames hung inside the hive compartment box 2 as bees moves between frames 3, it is an object to illuminate all of the spaces created between the frames 3. For instance, if the hive compartment box 2 has eleven frames 3a-3k as illustrated in FIG. 4, the frames creates ten void spaces between them, and the number of light units 6 inside the hive compartment box 2 would preferably be ten, or twenty if illuminated from both sides. Other variants may also be preferable depending on the layout of the frames 3 and the hive compartment box 2, as there may be a void space between the wall of the hive compartment box and the first and last frames. In these cases, a light unit 6 may be placed between the wall of the hive compartment box and the first and/or the last frame in addition the light units between the frames. When discussing placement of light units on or in “between the frames” is should be understood that this is either on the wall portion facing the void space “between the frames” or in the top module facing the void space “between the frames” from the top.

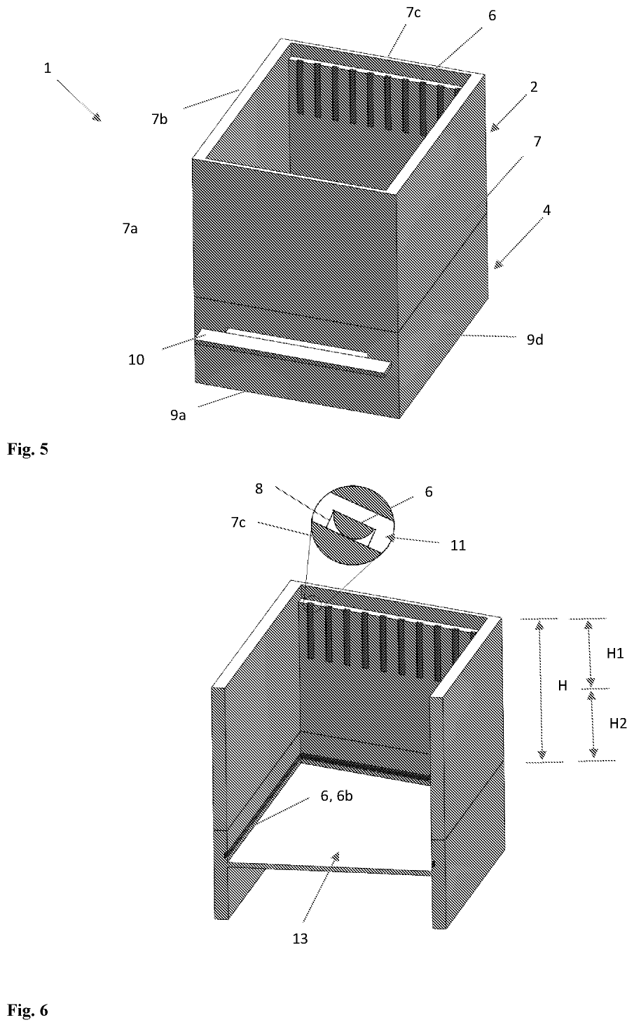

In FIG. 5 a hive structure 1 is shown from a front view. The forward-facing portion comprises the bee entrance 5 to the hive structure 1 and the entrance landing board 10 for bees to take off from and land before entering or exiting the hive 1. In FIG. 5 the hive compartment box 2 is illustrated with four upright quadrilateral wall plates 7a. 7b. 7c. 7d in a quadrilateral lay out in a manner forming a four-sided box open in the top and bottom.

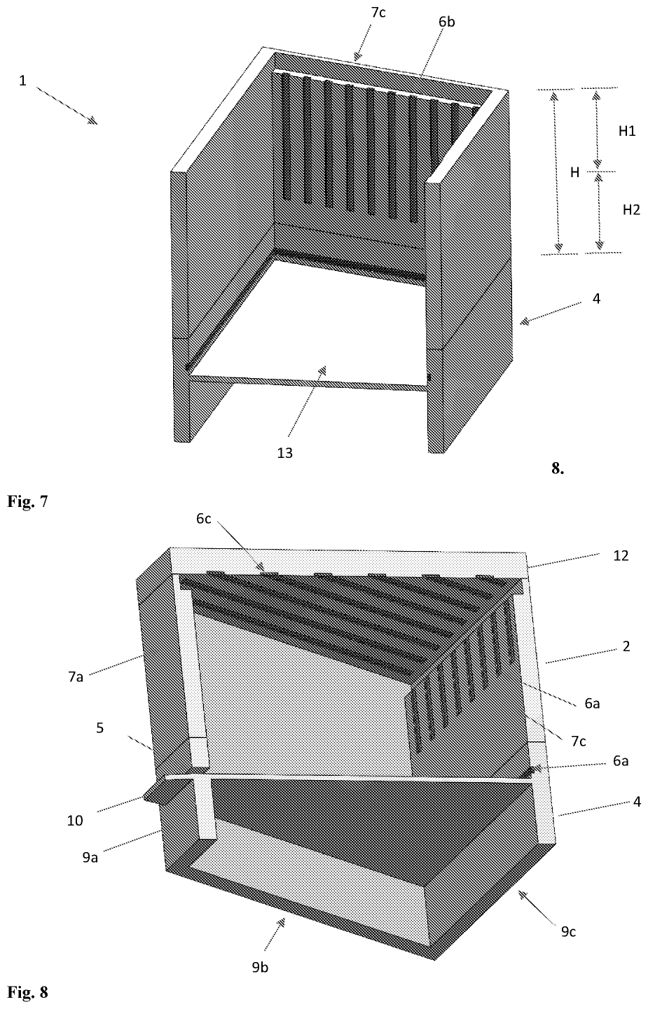

In FIG. 6 a hive structure is shown from a front view with a cut out of the front portion. A magnified portion of the FIG. 6 illustrates a cut-out portion, or groove. 8 in which the light unit 6 is situated in a manner not protruding the interior portion of the hive compartment wall 7c. The depth and width of the groove 8 is adapted by the dimensions of the LEDs of the light unit 6 or by the dimensions of a protective transparent cover housing a strip arrangement of LEDs. The length of the groove 8 is adapted to the length of the individual lengths or heights of the light unit 5. In FIG. 6 the light units 6a is positioned inside of a hive compartment box 2 and has a height, or vertical extent, less than half the height of both the frames and the height h of the hive compartment box 2. Furthermore, the light units 6b are in the illustrated example positioned on the top half H1 of the wall 7b inside the hive compartment box 2. Whereas in FIG. 7, the light units 6a is positioned inside of a hive compartment box 2 and has a height, or vertical extent, at least half the height of the frames or the height H of the hive compartment box 2. In both FIGS. 6 and 7 the length of the groove 8 is adapted to the length of the light units 6b. The grooves 8 may be covered with a protective transparent material, to protect the light units and to cover up any cavities or grooves so the bees do not “glue” them shut or build comb structures inside the grooves, thereby covering up the light unit.

The entrance chamber box 4 sits on the bottom of the hive structure 1, and normally comprises an entrance 5, four upright walls 9a. 9b. 9c. 9d. In the shown example in FIG. 5 the entrance 5 is a cut out slit, hole or opening in the forward-facing wall 9a. The entrance may be other types of configurations, for instance passes through a lock for selectively letting different species of insects in or out. The entrance chamber box 4 comprises a separating member between the ground (not shown) or the structure on which the hive 1 is situated, and the internal space of the hive. In the shown example this feature is achieved with the floor section 13. The floor section, or bottom board. 13 is fastened to the walls 9a-9d of the entrance chamber box 4.

Not shown in the figures are the electrical wiring between light units 6 and other electric components such as power sources and control units. It is obvious to a person skilled in the art the wires may be pulled through walls, inside or outside the walls, and how they interconnect to the required components. The electrical components of the system are powered by a power source, which is necessary to provide power to the light units in order for the light unit 6 to emit light. The power source may be at least one battery and/or at least one external power source and/or at least one power generating device.

In FIG. 8 an intersected view of the hive 1 is shown where the intersection plane intersects the front and back of the compartment box walls 7a. 7c and the entrance chamber box walls 9a. 9c. In FIG. 8 the underside of the top module 12 positioned on top of the hive compartment box 2. The top module 12 comprises, in the shown example, ten light units 6c emitting light with a predetermined beneficial wavelength down in the hive compartment box 2, which in this example is a brood box. To achieve emitting lights down into the hive compartment box 2, the ten light units 6c are attached in the roof portion of the top module and are downward facing and positioned in to the open space crated between two opposing frames in the least one hive compartment box 2 in a manner emitting light between the frames of the hive compartment box. In light units 6c runs the total internal length of the top module 12. In other embodiments the top module 12 may be a standard cover, without the light unit 6.

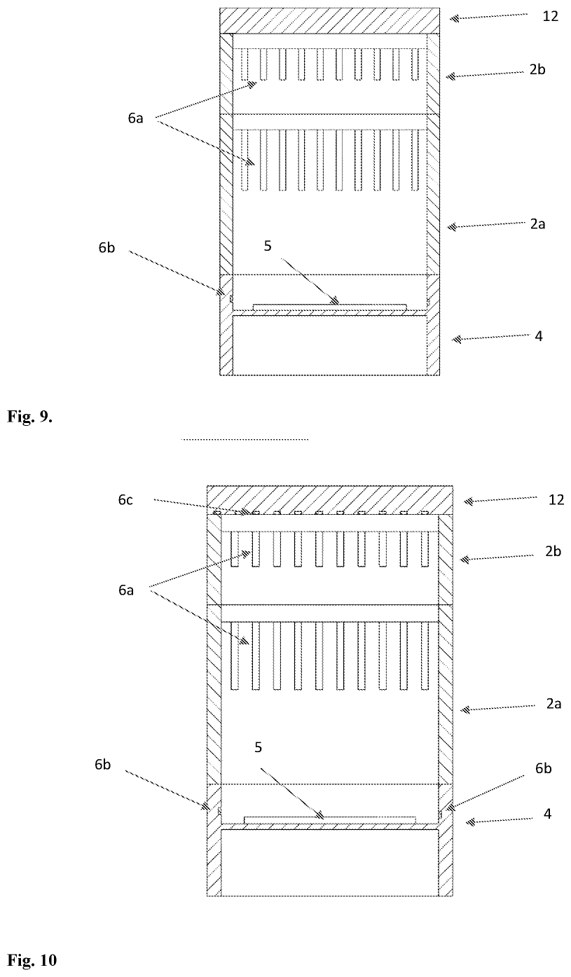

FIG. 9 illustrates an embodiment of the invention wherein two hive compartment boxes 2a. 2b, are stacked on top of each other. In the illustrated example both the bottom hive compartment box 2a and the top hive compartment box 2b comprises light units 6. Furthermore, the entrance chamber box 4 comprises light units 6. This configuration is typical when producing honey. Typically, the bottom hive compartment box 2a is the brood box and the top hive compartment box 2b is the honey super box. In the illustrated example both boxes 2a. 2b comprises light units 6a.

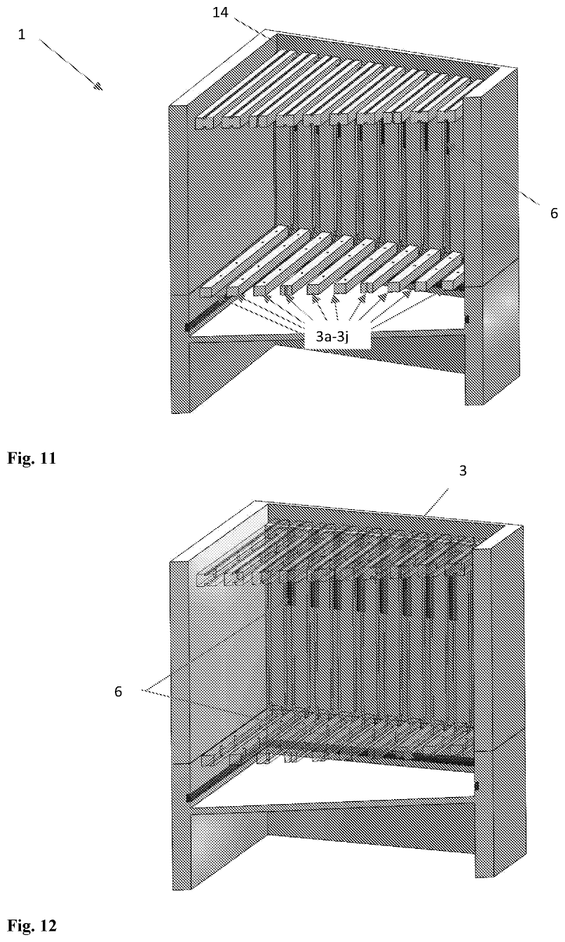

In FIG. 10 another embodiment of the invention wherein the system comprising two hive compartment boxes 2a. 2b, however, in this example the top module 12 also comprises light units 6. Typically, in this configuration, the top hive compartment box 2b is shorter than the bottom hive compartment box 2a.

In FIG. 11 a hive comprising a therapeutic light device according to an embodiment of the invention is illustrated. Ten frames 3a-3j are seen in a cut-out cross-section view to display the inner workings of the hive system. The frames 3a-3j are shown with a lower, an upper and one side frame member. In the illustrated example the frames would normally have four frame members to constitute a frame. i.e. two side frame members and an upper and a lower frame member. Not shown is the hexagonal comb structure inside the frame, wherein the bees store honey, pollen, nectar and eggs.

In FIG. 12 the hive is shown in the same position and with the same cross section view as in FIG. 11. In this example the frames 3 are illustrated as see through to show the light units 6 on the wall 7 of the hive compartment box 2. The Light units 6 are also present in the example illustrated in FIG. 11 but are obscured from view by the frames 3. Also shown in both the examples of FIGS. 11 and 12 are a light unit 6b in the bottom the entrance chamber box 4. The light configuration in in FIGS. 11 and 12 would illuminate the space under the frame sand the space between the frames, ensuring an even coverage of the free or open spaces in hives, and thereby an even coverage of the bees in these spaces, when bees are residing in the hive.

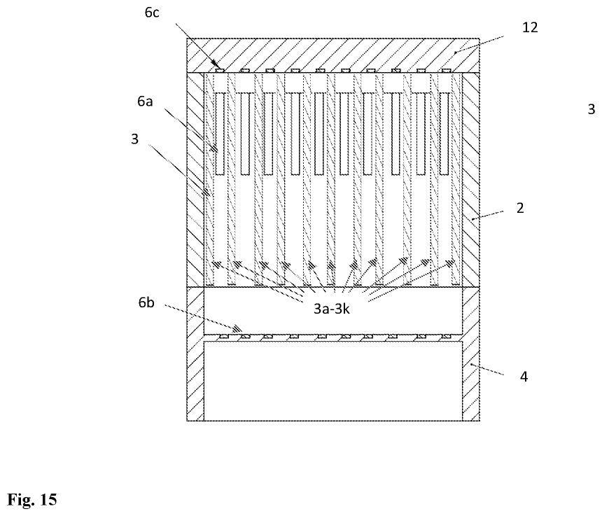

Furthermore, in an embodiment as display in FIG. 15, the at least one light unit 6b positioned inside the entrance chamber 4 and positioned in or on the floor portion 13 in a position corresponding to the open space between two adjacent frames located in the at least one hive compartment box 2 above. This alternative ensures the illumination of the space both inside the entrance chamber 4 and in between the frames, if in position, inside the hive compartment box 2 which is placed above said entrance chamber box 4.

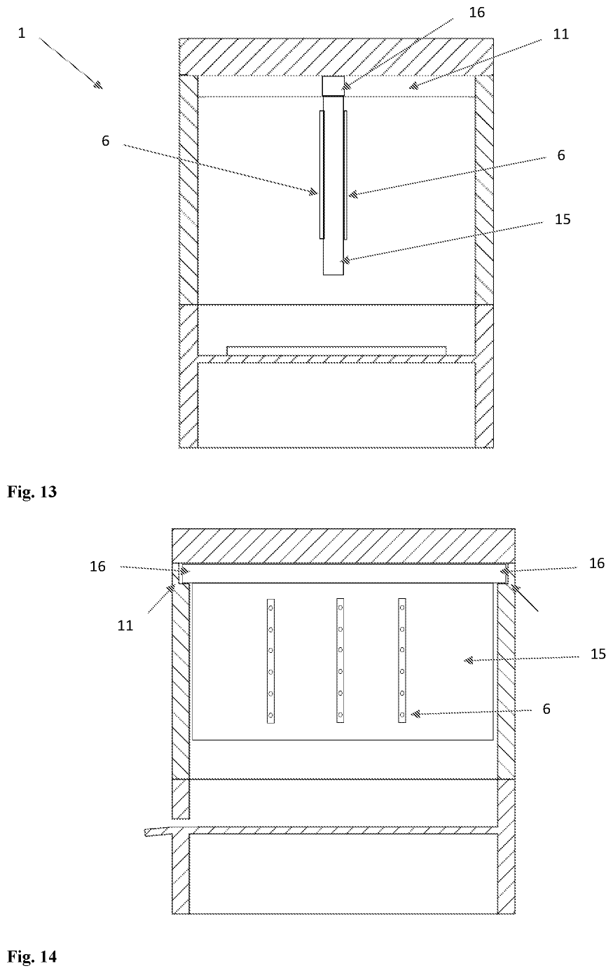

In FIGS. 13 and 14 it is illustrated a system comprising a light therapy device 15 that has similar attachment notches 16 and wherein the noches 16 are spaced apart the same width of a frame, and hung, or fastened, inside at least one hive compartment box 2 in the same way as at least one frame 3. In this embodiment the light therapy device 15 is positioned inside the at least one hive compartment box 2 by releasably attaching the device 15 in a manner similar to hanging, or placing, a frame 3.

In FIG. 13 the hive is seen in a front view, i.e. the entrance 6 in the entrance chamber is in the front of the figure. And in FIG. 14 the hive 1 is seen in a side view, i.e. the entrance 6 of the hive is orientated to the left side of the figure.

In said embodiment it is provided a system for light treatment of pollinating insects comprising a hive structure 1 comprising at least one hive compartment box 2 comprising a pair of parallel opposing shelf like grooves 11 on the top part of the inside portion of two opposing wall structures 7 of the at least one hive compartment box 2, wherein the opposing grooves 11 are adapted to receive multiple frames 3 spaced apart a predetermined distance. In said embodiment the grooves 11 are also adapted to facilitate or hold a light therapy device 15 as herein disclosed below between the two opposing grooves 11 on the inside of the at least one hive compartment box 2. The light therapy device 15 comprises at least one light unit 6, wherein the at least one light unit 6, when turned on, emits light with a predetermined beneficial wavelength, wherein the light therapy device 15 is releasably attachable to the at least one hive compartment box 2 with attachment means (11, 16). Said attachment means comprises a pair of notches 16, each notch protruding from opposite side, respectively, of the light therapy device 15 and wherein the opposite protruding notches 16 corresponds to the opposing grooves 11 on the inside of the at least one hive compartment box 2. For the protruding notches 16 of the light therapy device 15 to be releasable fastenable to the inside of the hive 1, the notches 16 must be spaced apart a distance equal to the distance between the shelf like grooves 11 of the interior of the hive 1, or at least one hive compartment box 2. In this embodiment the light therapy device 15 has a width substantially corresponding to the width of the interior space adapted for the frames 3. To ensure illumination on both sides of the he light therapy device 15, the device 15 might comprise at least two light units 6, each light unit illuminating the space on opposite sides of the light therapy device. In FIG. 13, three light units 6, each comprised of a LED strip, is illustrated. Alternatively, the device 15 can comprise one light unit illuminating, from a singular point, in a sphere like illumination pattern, not shown. In said embodiment the light unit is position in situ of at least one frame. In some embodiments the therapy device 15 is positioned on a framed feeder or the light therapy device can comprise a framed feeder. A framed feeder is a feeder in the shape of a frame, which would be known by a person skilled in the. The framed feeder comprises at least one compartment for storing food for the bees and at least one feeder dispenser outlet dispensing food to the bees. In certain situations, it can be a beneficial location to illuminate with the light therapy device 15, as the bees tends to gather around the feeder. In said situations the at least one light units of the therapy device might be positioned on said framed feeder, in a manner illuminating the open space around the framed feeder.

Other examples of the system for light treatment of pollinating insects is a hive structure 1 comprising at least one hive compartment box 2 adapted for receiving multiple frames 3 spaced apart a predetermined distance inside, and an entrance chamber 4 positioned bellow the at least one hive compartment box 2, wherein the entrance chamber 4 is in contact with the at least one hive compartment box 2, and comprises an entrance 5 for pollinating insects to enter and exit the hive structure 1, and a top module 12 placed on top of the at least one hive compartment box 2, wherein the top module 12 positioned on top of the at least one hive compartment box 2, wherein the top module 12 comprises a light therapy device. Said light therapy device comprises at least one light unit 6c, wherein the at least one light unit 6c, when turned on, emits light with a predetermined beneficial wavelength. In an embodiment the at least one light unit 6c is downward facing and positioned in the open space crated between two opposing frames 3 in the at least one hive compartment box 2 in a manner emitting light between the at least two frames 3 of the at least one hive compartment box 2. Said top module 12 can be a normal top cover protecting the hive from the outside, it can be a top feeder, or it can be a combination of a top cover and a feeder. In situations where it its beneficial the top module 12 is removable to allow access to the inside of the hive 1 by removing the top.

The system of the above illustrated examples may be used in a method in accordance with an embodiment of the invention to heal and treat against pesticide and other stressful or damaging elements, and to have a prophylactic effect on the bees. To treat and heal the bees in the wild or in places where beekeepers house and keep their bees must be exposed to the correct amount of light emitted from the light therapy device as comprised in the system in according to the inviting. The system must therefore be used as the bees habituating habitat. The predetermined interval for turning the at least one light unit 6 of the light therapy device on and off, must be decided on based on the time of the year, the pesticide situation from nearby fields and the time of the day. Fore instance if nearby fields or crops are spread with neonicotinoids or other pesticides, there would be a need to increase the longitude of exposure or the number of light units emitting the therapeutic light frequency of preferably between 620-1000 nm, and more preferably between 640-700 nm, and even more preferably between 660-680 nm. During the light exposure the bees would practice their daily routine of pollinating, harvesting food and producing honey, while the light therapy device comprised in the system would heal and treat the bees unobtrusively, not affecting the bees in any negative way. This means that the normal flow and transportation of bees, larva, brood and honey should not be affected by hinders or obstacles normally not found in bee hives. A beekeeper may utilize several systems according to the above-mentioned embodiments multiple hives and colonies, in order to achieve a collective healing and strengthening effect on entire colonies stretching over large areas.

Although specific embodiments of the invention have been described and illustrated herein, it is recognized that modifications and variations may readily occur to those skilled in the art, and consequently, it is intended that the claims be interpreted to cover such modifications and equivalents.

### REFERENCE NUMERALS

1 The hive
2 Hive compartment box
2a, 2b Top and bottom hive compartment box
3 Frames
3a-3k Frames
4 Entrance chamber box, bottom board
5 Entrance in the entrance chamber box
6 Light unit
6a-6c Light units
7 Walls of hive compartment box
7a-7d Walls of hive compartment box
8 Groove for light unit
9 Walls of the entrance chamber box
9a-9d Walls of the entrance chamber box
10 Landing board
11 Grooves adapted for receiving frame notch
12 Top module, top cover
13 Bottom floor board in the bottom board
14 Frame notches
15 Releasably attachable light therapy device
16 Notch protruding from opposite sides of the releasably attachable light therapy device

1.-26. (canceled)

27. A system for light treatment of pollinating insects comprising;
a hive structure comprising at least one hive compartment box comprising a plurality of frames spaced apart inside the at least one hive compartment box and an entrance chamber (4) positioned below the at least one hive compartment box,
wherein the entrance chamber is in contact with the at least one hive compartment box and comprises an entrance for pollinating insects to enter and exit the hive structure, and;
a light therapy device,
wherein the light therapy device comprises at least one light unit, wherein the at least one light unit, when turned on, emits light with a predetermined wavelength, wherein the at least one light unit is positioned:
inside of the at least one hive compartment box fastened to or in at least one side wall of a plurality of sidewalls of the at least one hive compartment box, wherein the at least one light unit has a vertical extent and is positioned on or in the at least one side wall between a position of at least two frames of the plurality of frames, illuminating a space created by a void between at least two frames;
and/or;
inside the entrance chamber, wherein the at least one light unit is positioned on or in at least one wall or floor inside the main entrance chamber; and
wherein the at least one light unit is fixated in corresponding grooves in the at least one wall or floor, wherein the corresponding grooves include a depth corresponding to a width of the at least one light unit, for the at least one light unit to not protrude the plurality of walls and into an open space inside the at least one hive compartment box or inside the entrance chamber.

28. The system of claim 27, wherein the at least one light unit, positioned inside of the at least one hive compartment box, has a vertical extent of at least half of a height of the frames.

29. The system of claim 27, wherein the at least one light unit is positioned on a top half of the wall inside the at least one hive compartment box.

30. The system of claim 27, wherein the at least one light unit, positioned inside of the at least one hive compartment box, has a vertical extent of less than half of a height of the frames.

31. The system of claim 27, wherein the at least one light unit, if positioned inside the entrance chamber, has a longitudinal extent corresponding to at least half of a width or longer of the wall where the at least one light unit is positioned.

32. The system of claim 27, wherein the at least one light unit is positioned on or in at least two walls of the plurality of walls in the entrance chamber, wherein the said at least two walls are opposing each other.

33. The system of claim 27, wherein the at least one light unit, if positioned inside the entrance chamber, is positioned in or on a floor portion of the hive structure in a position corresponding to the open space between two frames located in the at least one hive compartment box above.

34. The system of claim 27, further comprising at least two light units when positioned inside of the at least one hive compartment box, wherein the at least two light units are positioned on opposing walls, respectively, aligned in the space between at least two frames.

35. The system of claim 27, further comprising at least two light units when positioned inside of the at least one hive compartment box, wherein the at least two light units are positioned on or in at least one wall and between one or multiple pairs of opposing frames, wherein a distance between the at least two light units corresponds to a distance of the plurality of frames.

36. The system of claim 27, wherein the hive structure further comprises a top module positioned on top of the at least one hive compartment box, wherein the top module comprises at least one light unit emitting light with a predetermined wavelength when turned on, wherein the at least one light unit is downward facing and positioned to the open space crated between two opposing frames in the at least one hive compartment box emitting light between the frames of the at least one hive compartment box.

37. The system of claim 36, wherein the top module is a top feeder.

38. The system of claim 27, further comprising a control unit for selectably switching the light therapy device on and off.

39. The system of claim 38, wherein the control unit controls when the light therapy device is turned on and when the light therapy device is turned off.

40. The system of claim 38, wherein the control unit for selectably switching the light therapy device on and off is remotely configurable via a remote control.

41. The system of claim 38, wherein the control unit is configurable to control parameters for predetermined light intervals, wherein said parameters are at least one of: (i) the light exposure duration, (ii) a duration of an off-time, or (iii) a frequency of the intervals.

42. The system of claim 27, wherein the at least one light unit is powered by at least one battery or at least one external power source or at least one power generating device.

43. The system of claim 27, wherein the pollinating insects are honey bees or bumblebees.

44. The system of claim 27, wherein the at least one light unit comprises at least one light emitting diode (LED) or a plurality of light emitting diodes (LEDs) configured in a strip arrangement.

45. The system of claim 27, wherein the predetermined wavelength is preferably between 620-1000 nm, more preferably between 640-700 nm, and even more preferably between 660-680 nm.

46. A method for treatment of pollinating insects inside a hive comprising the system of claim 27, wherein the method comprises:
housing pollinating insects inside said hive;
selecting a predetermined time interval for turning the at least one light unit of the light therapy device on and off; and
illuminating the pollinating insects for the predetermined time interval with the at least one light unit.
